(19) United States
(12) Patent Application Publication
(10) Pub. No.: US 2026/0258846 A1
(43) Pub. Date: Sep. 3, 2026

(54) AXLE DISCONNECT ARRANGEMENT

(71) Applicant: Eaton Intelligent Power Limited, Dublin (IE)

(72) Inventors: Nikhil S. Mahajan, Maharashtra (IN); Pritam S. Bhurke, Maharashtra (IN)

(73) Assignee: Eaton Intelligent Power Limited, Dublin (IE)

(21) Appl. No.: 19/470,479

(22) PCT Filed: Mar. 29, 2024
(86) PCT No.: PCT/IB2024/053099

§ 371 Date: Sep. 29, 2025

Related U.S. Application Data
(60) Provisional application No. 63/493,366, filed on Mar. 31, 2023.

(51) Int. Cl. F16D 27/118; B60K 17/02; B60K 17/04; F16D 11/14; F16H 1/06

(52) U.S. Cl. CPC F16D 27/118; B60K 17/02; B60K 17/043; F16D 11/14; F16H 1/06

(57) ABSTRACT

A disconnect unit allows one axle of a vehicle to be disconnected from the drivetrain. The disconnect unit is electronically controlled via an electromagnet. Certain types of disconnect units can be packaged within the gear reduction unit. Certain types of disconnect units include a stator holding an electromagnet, a support link rotationally fixed to an intermediate shaft, and a shiftable lock plate rotationally fixed to the support link. The lock plate shifts in and out of engagement with a gear output based on the actuation state of the electromagnet.

### CROSS-REFERENCE

This patent application claims the benefit of U.S. Provisional Application No. 63/493,366, filed Mar. 31, 2023 and titled “Axle Disconnect Arrangement,” the disclosure of which is hereby incorporated herein by reference in its entirety.

### BACKGROUND

Reduction drive units generally include a drive motor, a shaft driven by the drive motor, and a reduction gear train driven by the shaft. The reduction gear drives a wheel hub of a vehicle. Such reduction drive units are known in the art and are exemplified by U.S. Pat. Nos. 3,686,978 and 3,737,000.

### SUMMARY

Aspects of the disclosure are directed to an axle disconnect unit for use in disconnecting a wheel hub from a drive motor. For example, an axle driving the wheel hub can be disconnected from a reduction gear driven by the drive motor. Under certain conditions, fewer than all wheels are sufficient to provide the required power to the vehicle. In such conditions, disconnecting one or more of the wheels from the drive motor can save power and enhance the efficiency of the vehicle. In certain implementations, a wheel can be disconnected from the drive motor by disconnecting an axle of the wheel from the drive motor.

In accordance with certain aspects of the disclosure, the disconnect unit can be packaged with a gear reduction unit. The gear reduction unit receives power from the drive motor and outputs power through an output gear. The gear reduction unit also includes an intermediate shaft that couples to the wheel axle to drive the wheel. The disconnect unit controls when the output gear connects to the intermediate shaft. In certain examples, the output gear, the intermediate shaft, and the disconnect unit are disposed within a common housing.

In accordance with certain aspects of the disclosure, the disconnect unit has a first portion connected to the intermediate shaft and a second portion that selectively connects to the output gear. The first portion is configured to entrain the intermediate shaft when the first portion is rotated. The second portion is axially movable relative to the first portion to selectively engage the output gear. The second portion is rotationally fixed relative to the first portion. Accordingly, when the second portion engages the output gear, rotation of the output gear is transferred to the first portion and, thereby, to the intermediate shaft. When the second portion is separated from the output gear, rotation of the output gear is not transferred to the intermediate shaft.

In certain implementations, movement of the second portion is controlled using an electromagnet.

In some implementations, the second portion is biased into engagement with the output gear. In other implementations, the second portion is biased out of engagement with the output gear.

In certain implementations, the first portion of the disconnect unit includes a support link. In certain implementations, the second portion of the disconnect unit includes a lock plate.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a schematic diagram of an example drive system including a drive motor, a disconnect unit, and a vehicle wheel, the disconnect unit configured in accordance with the principles of the present disclosure;

FIG. 2 is a schematic diagram of an example drive system including a drive motor, a gear reduction unit, and a wheel axle, the gear reduction unit including a disconnect unit configured in accordance with the principles of the present disclosure;

FIG. 3 is an exploded view of an example implementation of the gear reduction unit of FIG. 2, the gear reduction unit including an output gear, an intermediate shaft, and an example disconnect unit packaged within a housing;

FIG. 4 is an axial cross-sectional view of components of the gear reduction unit of FIG. 3 shown in a connect state;

FIG. 5 is an axial cross-sectional view of components of the gear reduction unit of FIG. 3 shown in a disconnect state;

FIG. 6 is an exploded view of another example implementation of the gear reduction unit of FIG. 2, the gear reduction unit including an output gear, an intermediate shaft, and an example disconnect unit packaged within a housing;

FIG. 7 is an axial cross-sectional view of components of the gear reduction unit of FIG. 6 shown in a connect state; and

FIG. 8 is an axial cross-sectional view of components of the gear reduction unit of FIG. 6 shown in a disconnect state.

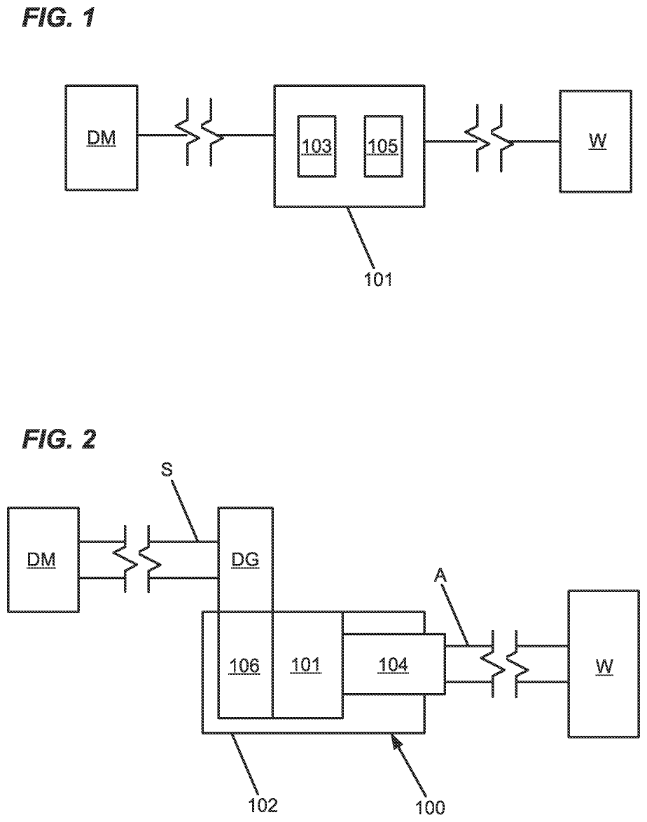

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

In accordance with certain aspects of the disclosure, a disconnect unit 101 is operationally disposed between a drive motor DM and a vehicle wheel W. In certain implementations, the disconnect unit 101 is indirectly connected to the drive motor (e.g., via a drive gear, drive shaft, etc.). In certain implementations, the disconnect unit 101 is indirectly connected to the vehicle wheel (e.g., via a wheel axle, etc.). The disconnect unit 101 controls whether the drive motor DM provides power to the vehicle wheel W. The disconnect unit 101 is configured to transition between a connecting state and a disconnecting state. When in the connecting state, the disconnect unit 101 connects the drive motor DM to the vehicle wheel W. When in the disconnecting state, the disconnect unit 101 removes the connection between the drive motor DM and the vehicle wheel W.

In certain implementations, the disconnect unit 101 includes an electromagnet 103 and a ferrous component 105. The ferrous component 105 is movable between first and second positions. When the ferrous component 105 is disposed in the first position, the disconnect unit 101 is configured in the connect state. When the ferrous component 105 is disposed in the second position, the disconnect unit is configured in the disconnect state. In certain examples, the ferrous component 105 is biased towards one of the first and second positions. When actuated, the electromagnet 103 moves the ferrous component 105 against the bias towards the other of the first and second positions. Accordingly, in some examples, actuating the electromagnet 103 transitions the disconnect unit 101 to the connect state. In other examples, actuating the electromagnet 103 transitions the disconnect unit 101 to the disconnect state.

In accordance with certain aspects of the disclosure, the disconnect unit 101 can be disposed within a gear reduction unit 100. The gear reduction unit 100 includes a housing 102 in which an intermediate shaft 104 and a gear output 106 (e.g., a stage one gear output) are disposed. In the drawing figures, the gear output 106 is shown without teeth for convenience. It will be understood, however, that the gear output 106 is a spur gear, a helical gear, or the like having outer peripheral teeth (e.g., for meshing with a drive gear DG of the drive motor DM). An axle A of a vehicle wheel W can be coupled to the intermediate shaft 104 for rotation therewith. Torque from a drive motor DM can be supplied to the gear output 106 of the gear reduction unit 100. However, the gear output 106 is not directly rotationally locked to the intermediate shaft 104. For example, the gear output 106 may define a smooth interior passage through which the intermediate shaft 104 passes and/or the intermediate shaft 104 may define a smooth exterior extending through the gear output 106. Connection and disconnection of the gear output 106 and the intermediate shaft 104 is controlled using the disconnect unit 101.

In accordance with certain aspects of the disclosure, the disconnect unit 101 is disposed within the housing 102 of the gear reduction unit 100. The disconnect unit 101 controls whether the intermediate shaft 104 is operationally connected to the gear output 106. Accordingly, the disconnect unit 101 controls whether or not the drive motor DM is operationally connected to the axle A of the wheel W. The axle A may be connected to one or more wheels W of the vehicle.

In certain implementations, the disconnect unit 101 rotationally couples or decouples the intermediate shaft 104 and the gear reduction unit 100 through the use of an electromagnet 112. The electromagnet 112 is configured to generate a magnetic field when current is drawn through the electromagnet 112. The electromagnet 112 ceases to generate a magnetic field when current is no longer provided to the electromagnet 112. The generation of the magnetic field causes movement (e.g., sliding movement) of the ferrous component 105 of the disconnect unit 101 into and out of engagement with the gear output 106. The ferrous component 105 is rotationally locked, directly or indirectly, to the intermediate shaft 104. Accordingly, when the ferrous component 105 is engaged with the gear output 106, the rotation of the gear output 106 is transferred to the intermediate shaft 104 through the ferrous component 105.

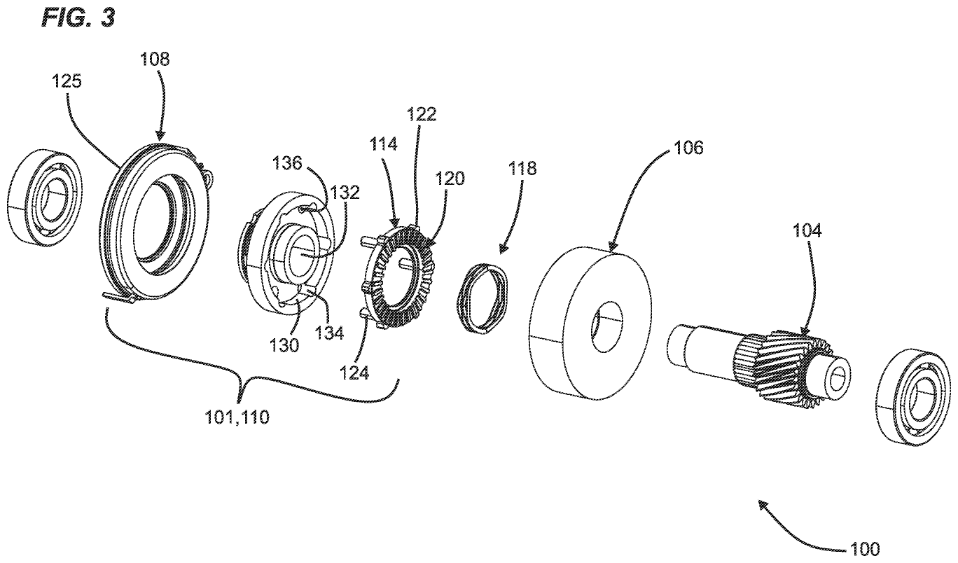

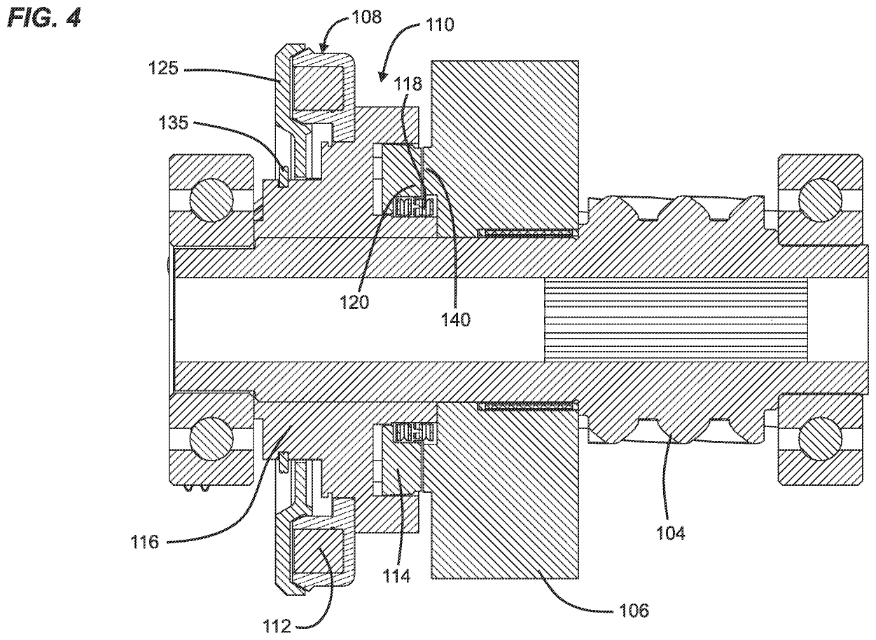

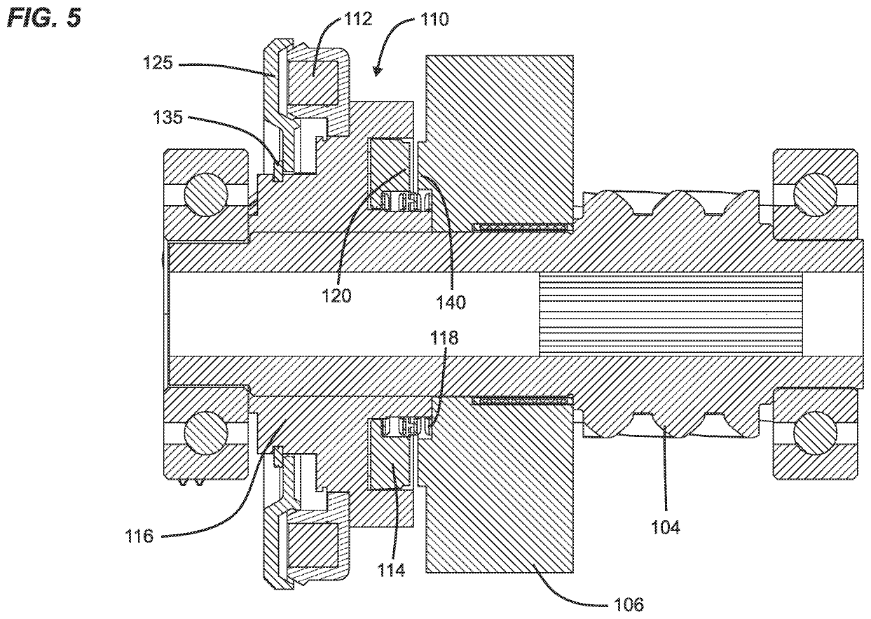

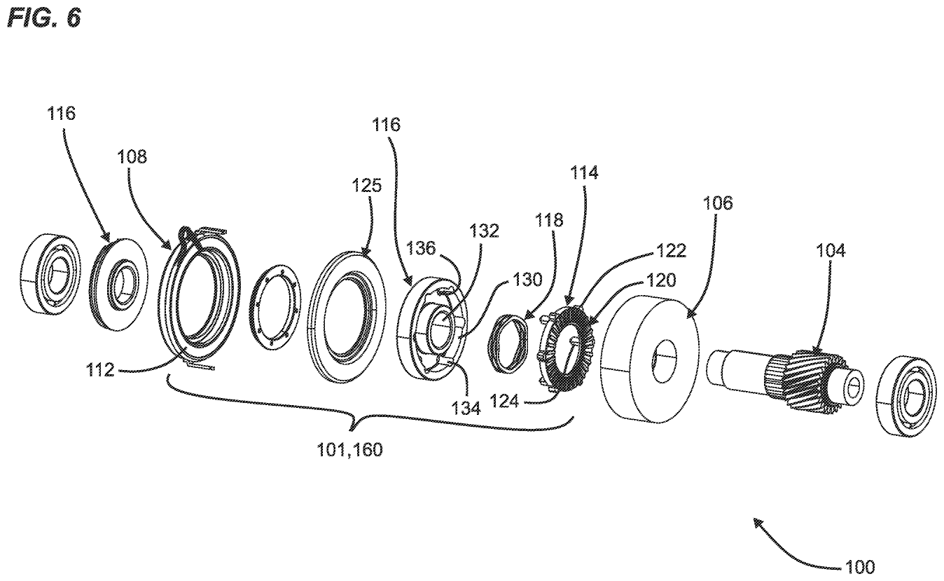

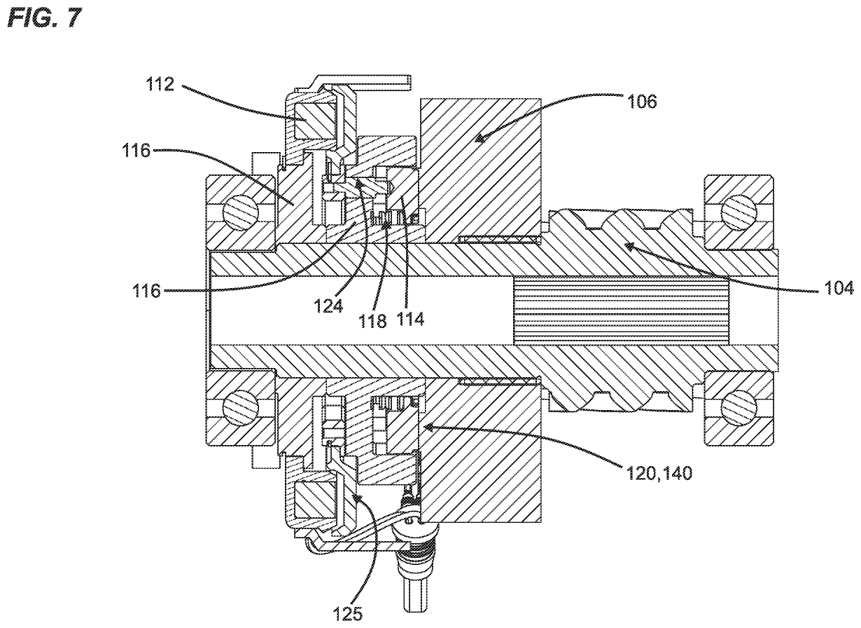

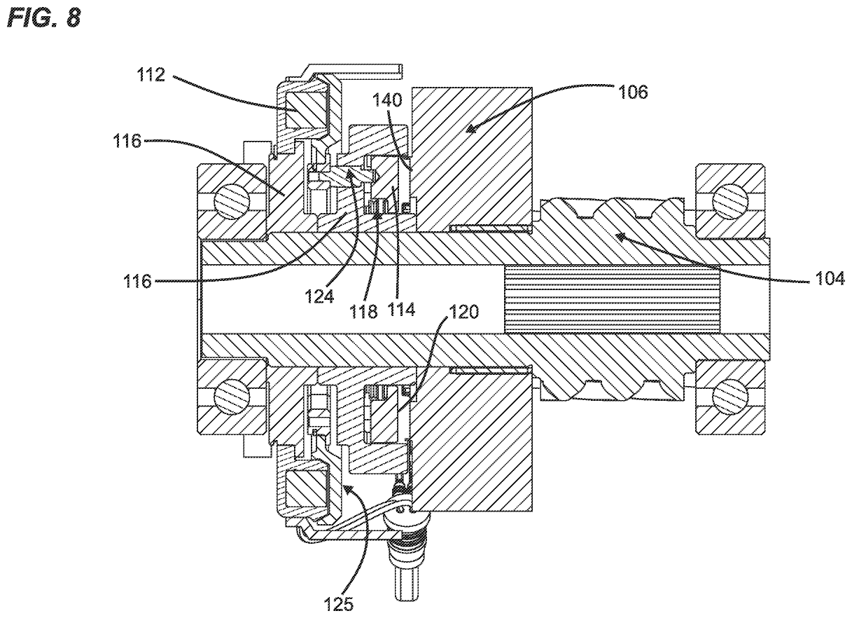

FIGS. 3-5 illustrate a first example implementation of a disconnect unit 110 disposed within a gear reduction unit 100. The first disconnect unit 110 is configured to maintain a disconnect between the drive motor and the vehicle wheel until the electromagnet is actuated. FIGS. 6-8 illustrate a second example implementation of a disconnect unit 160 disposed within a gear reduction unit 100. The second disconnect unit 160 is configured to maintain a connection between the drive motor and the vehicle wheel until the electromagnet is actuated.

Referring to FIGS. 3-8, in certain implementations, the disconnect unit 110, 160 includes a stator assembly 108, a lock plate 114, a support link 116. The intermediate shaft 104 extends through the lock plate 114, the support link 116, and the stator assembly 108. The stator assembly 108 is disposed within the housing 102 of the gear reduction unit 100. The stator assembly 108 is rotationally stationary relative to the housing 102. The intermediate shaft 104 is configured to rotate relative to the stator 108. In certain implementations, the electromagnet 112 is mounted to the stator 108.

In certain implementations, the lock plate 114 includes one or more dog teeth 120 or other engagement members that extend axially away from the lock plate 114 towards the gear output 106. The gear output 106 also includes dog teeth 140 or other engagement members that extend axially towards the lock plate 114. Engagement between the dog teeth 120 (or other engagement members of the lock plate 114) and the dog teeth 140 (or other engagement members of the gear output 106) rotationally locks the lock plate 114 for unitary rotation with the gear output 106. Other meshing configurations are possible.

The lock plate 114 is indirectly rotationally coupled to the intermediate shaft 104 so that rotation of the lock plate 114 is translated into rotation of the intermediate shaft 104. Accordingly, sliding the lock plate 114 into engagement of the gear output 106 will transfer rotation of the gear output 106 to rotation of the intermediate shaft 104. Sliding the lock plate 114 out of engagement with the gear output 106 rotationally decouples the intermediate shaft 104 from the gear output 106.

In certain implementations, a support link 116 is rotationally locked to the intermediate shaft 106. For example, the support link 116 may define splines (not shown) or other engagement features at an interior passage 132 of the support link 116 to mesh with engagement features at an exterior of the intermediate shaft 104. In certain implementations, the support link 116 also is rotationally locked to the lock plate 114. For example, the support link 116 may define catch surfaces 134 that engage retention members 122 of the lock plate 114. In certain examples, the retention members 122 protrude radially outwardly from a periphery of the lock plate 114 and the catch surfaces 134 are formed at inwardly facing grooves of the support link 116.

In some implementations, the support link 116 is axially stationary relative to the stator 108. In other implementations, the support link 116 axially floats relative to the stator 108. The support link 116 defines a recess 130 in which the lock plate 114 is disposed. The lock plate 114 is axially movable relative to the support link 116 between first and second positions. When disposed in the first position, the lock plate 114 engages the gear output 106. When disposed in the second position, the lock plate 114 does not engage (e.g., is spaced from) the gear output 106. In certain implementations, the lock plate 114 is rotationally locked to the support link 116 in both axial positions.

Pins 124 extend from the lock plate 114 away from the gear output 106 towards the stator 108. In certain implementations, the pins 124 move axially with the lock plate 114 as a unit. In certain implementations, the pins 124 pass through guide holes 136 defined through the support link 116. In certain examples, the guide holes 136 extend parallel to the passage 132 through the support link 116. The pins 124 slide along the guide holes 136 as the lock plate 114 moves between the first and second positions.

An armature 125 is mounted to the support link 116 at a location spaced from the lock plate recess 130. For example, the armature can extend around a mounting region of the support link 116. The armature 125 is configured for limited axial movement relative to the support link 116. For example, the support link 116 may include or carry a stop member 135 that inhibits movement of the armature 125 off the support link 116. The pins 124 of the locking plate 114 are sufficiently long to extend through the support link 116 and contact the armature 125. In certain implementations, the armature 125 includes or carries ferrous material. For example, a portion of the armature 125 axially aligned with the electromagnet may be formed of ferrous material.

Referring now to FIGS. 3-5, the gear output 106 of the first example disconnect unit 110 is disconnected from the intermediate shaft 104 absent an electromagnetic force generated by the electromagnet 112. A biasing element 118 (e.g., a spring) is disposed between the gear output 106 and the lock plate 114 to bias the lock plate 114 away from the gear output 106. The armature 125 is disposed at an opposite side of the stator 108 from the support link 116. When a current is drawn through the electromagnet 112, the ferrous metal is attracted to the electromagnet 112, thereby pulling the armature 125 towards the stator 108. As the armature 125 moves towards the stator 108, the armature 125 engages the pins 124 of the lock plate 114 and, thereby, pushes the lock plate 114 against the bias of the biasing element 118 and into engagement with the gear output 106. To disconnect the gear output 106 from the intermediate shaft 104 (and hence the drive motor from the axle), current to the electromagnet 112 is stopped. When the electromagnet 112 is shut off, the force of the biasing element 118 is sufficient to push the lock plate 114 out of engagement with the gear output 106.

Referring now to FIGS. 6-8, the gear output 106 of the second example disconnect unit 160 is connected to the intermediate shaft 104 absent an electromagnetic force generated by the electromagnet 112. A biasing element 118 (e.g., a spring) is disposed between the lock plate 114 and the support link 116 to bias the lock plate 114 towards the gear output 106. The armature 125 is disposed at a common side of the stator 108 as the support link 116. When a current is drawn through the electromagnet 112, the ferrous metal is attracted to the electromagnet 112, thereby pulling the armature 125 towards the stator 108 and away from the gear output 106.

In certain implementations, the pins 124 are axially locked to both the lock plate 114 and to the armature 125. Accordingly, as the armature 125 moves towards the stator 108, the armature 125 pulls the lock plate 114 out of engagement with the gear output 106 via the pins 124. The support link 116 allows sufficient axial movement of the armature 125 to pull the lock plate 114 out of engagement with the gear output 106. To again connect the gear output 106 to the intermediate shaft 104 (and hence the drive motor to the axle), current to the electromagnet 112 is stopped. When the electromagnet 112 is shut off, the force of the biasing element 118 is sufficient to push the lock plate 114 into engagement with the gear output 106.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1. A gear reduction unit comprising:
an intermediate shaft extending along an axis;
a stator disposed about the intermediate shaft;
a gear output mounted around the intermediate shaft;
a support link mounted over the intermediate shaft, the support link being axially fixed to the intermediate shaft, and the support link being configured to entrain the intermediate shaft when the support link is rotated;
a lock plate mounted axially between the support link and the gear output, the lock plate being movable along the axis relative to the support link between connecting and disconnecting positions, the lock plate being configured to engage the gear output when disposed in the connecting position, the lock plate being spaced from the gear output when disposed in the disconnecting position;
an armature mounted to the support link, the armature being configured for limited movement along the axis relative to the support link, the armature being connected to the lock plate to move unitarily with the lock plate between the connecting and disconnecting positions, and the armature including a ferrous metal; and
an electromagnet disposed at the stator, the electromagnet attracting the ferrous metal to move the armature along a first direction when the electromagnet is activated.

2. The gear reduction unit of claim 1, wherein moving the armature along the first direction moves the lock plate to the connecting position.

3. The gear reduction unit of claim 1, wherein moving the armature along the first direction moves the lock plate to the disconnecting position.

4. The gear reduction unit of claim 1, further comprising a biasing element configured to bias the lock plate in a second direction that is opposite the first direction.

5. The gear reduction unit of claim 1, wherein the support link includes internal splines configured to mesh with the intermediate shaft.

6. The gear reduction unit of any of claim 1, wherein the lock plate and the gear output each have dog teeth that mesh together when the lock plate is disposed in the connecting position.

7. The gear reduction unit of claim 1, wherein the lock plate includes retention members that engage catch surfaces of the support link to rotationally join the lock plate and the support link.

8. The gear reduction unit of any of claim 1, further comprising pins extending through the support link between the armature and the lock plate.

9. The gear reduction unit of claim 8, wherein the pins are unitarily formed with the lock plate.

10. The gear reduction unit of claim 4, wherein the support link includes a stop member that inhibits movement of the armature along the second direction beyond a first location to limit the travel of the armature relative to the support link.

11. A method of disconnecting an axle from a drive motor, the method comprising:
rotationally coupling the axle to a support link;
supplying a torque from the drive motor to a gear output;
drawing a current through an electromagnet of a stator to move an armature along the support link towards the stator against a bias of a spring;
moving a lock plate along the support link in unison with the armature from a connecting position with the gear output to a disconnecting position with the gear output.

12. The method of claim 11, wherein the spring is disposed between the lock plate and the support link.

13. The method of claim 11, further comprising reconnecting the axle to the drive motor including ceasing current to the electromagnet, thereby allowing the lock plate to move back to the connecting position under the bias of the spring.

14. A method of connecting an axle to a drive motor, the method comprising:
rotationally coupling the axle to a support link;
supplying a torque from the drive motor to a gear output; and
biasing a lock plate away from the gear output and towards the support link so that the lock plate is disposed in a disconnecting position relative to the gear output.

15. The method of claim 14, wherein biasing the lock plate away from the gear output includes disposing a spring between the lock plate and the gear output.

16. The method of claim 11, further comprising reconnecting the axle to the drive motor including:
drawing a current through an electromagnet of a stator to move an armature along the support link towards the stator against the bias; and
moving the lock plate along the support link in unison with the armature from the disconnecting position with the gear output to a connecting position with the gear output, wherein the lock plate engages the gear output to move in unison therewith when disposed in the connecting position.

17. A disconnect arrangement comprising:
a support link including a body extending along an axis between opposite first and second sides, the support link defining a passage extending along the axis therethrough, the support link also defining a recess at the first side of the body, and the support link defining a mounting region at the second side of the body;
a stator mounted to the support link at a location axially between the cavity and the mounting region, the stator including an electromagnet;
a lock plate disposed within the recess at the first side of the body, the lock plate being movable relative to the support link along the axis between first and second positions, the lock plate including peripheral retention members configured to engage catch surfaces of the support link to rotationally lock the lock plate to the support link, the lock plate also including dog teeth extending axially outwardly from the lock plate away from the support link;
an armature mounted to the support link at the mounting region, the armature being axially movable along the mounting region, the armature including a ferrous metal attractable by the electromagnet of the stator; and
pins extending through the support link between first and second ends, the first ends of the pins being secured to the lock plate, and the second ends of the pins being configured to engage the armature.

18. The disconnect arrangement of claim 17, further comprising a biasing element disposed at a common side of the lock plate as the dog teeth.

19. The disconnect arrangement of claim 18, wherein the ferrous metal of the armature is located at an opposite side of the stator from the lock plate.

20. The disconnect arrangement of claim 17, further comprising a biasing element disposed between the lock plate and the support link.

21. The disconnect arrangement of claim 20, wherein the ferrous metal of the armature and the lock plate are located at a common side of the stator.

22. The disconnect arrangement of claim 17, further comprising a gear output of a gear reduction unit, the gear output including dog teeth, the dog teeth of the gear output being configured to mesh with the dog teeth of the lock plate when the lock plate is disposed in one of the first and second positions, and the dog teeth of the gear output being configured to be spaced from the dog teeth of the lock plate when the lock plate is disposed in the other of the first and second positions.
